(19) United States
(12) Patent Application Publication
(10) Pub. No.: US 2026/0135308 A1
(43) Pub. Date: May 14, 2026

(54) CIRCUIT BOARD CONNECTOR

(71) Applicant: MOTOROLA SOLUTIONS, INC., Chicago, IL (US)

(72) Inventors: Lee Chee Pang, Baling (MY); Boon Aik Eeo, Bayan Lepas (MY); Weng Kong Hor, Butterworth (MY); Sze Yen Lim, Georgetown (MY); Imadi Safwan Samsudin, Kulim (MY); Yew Lam Tam, Georgetown (MY)

(21) Appl. No.: 18/941,321

(22) Filed: Nov. 8, 2024

(51) Int. Cl. H01R 12/70; H01R 12/71; H01R 12/73

(52) U.S. Cl. CPC H01R 12/7058; H01R 12/7082; H01R 12/714; H01R 12/732

(57) ABSTRACT

A circuit board to circuit board connector (“BTB connector”) is mounted to a printed circuit board that includes a first printed circuit board connector and a second printed circuit board connector. The BTB connector includes a frame having a base, a backing plate formed on the base for biasing the first printed circuit board connector to the printed circuit board, and a pair of support arms extending from the base. Each of the support arms includes a lock for receiving the printed circuit board to axially constrain the frame to the printed circuit board in a first direction, a stop abutting the second printed circuit board connector to rotationally constrain the first printed circuit board connector to the printed circuit board about a rotational axis extending in a second direction orthogonal to the first direction, and a catch for removably coupling the frame to the second printed circuit board connector.

### BACKGROUND

Internal components of portable electronic devices are commonly electrically connected to each other using various board-to-board connectors or other types of connectors. During assembly of the electronic components within the electronic devices, the various types of connectors can become loose or even electrically disconnect from respective internal connections within the electronic device. To prevent this from occurring, a separate board connector can be used to hold the other various connectors in place to maintain electrical contact with respective internal components.

### SUMMARY

The present disclosure provides, in one aspect, a circuit board to circuit board connector (“BTB connector”) configured to be mounted to a printed circuit board that includes a first printed circuit board connector and a second printed circuit board connector The BTB connector includes a frame having a base, a backing plate formed on the base is configured to bias the first printed circuit board connector to the printed circuit board, and a pair of support arms extend from the base. Each arm of the pair of support arms includes a lock configured to receive the printed circuit board to axially constrain the frame to the printed circuit board in a first direction. A stop is configured to abut the second printed circuit board connector and to rotationally constrain the first printed circuit board connector to the printed circuit board about a rotational axis extending in a second direction orthogonal to the first direction. The BTB connector also includes a catch for removably coupling the frame to the second printed circuit board connector.

The present disclosure provides, in another aspect, an electronic device that includes a housing having a first printed circuit board and a second printed circuit board spaced from the first printed circuit board in a first direction. A first printed circuit board connector is electrically coupled to the first printed circuit board, and a second printed circuit board connector opposite the first printed circuit board connector is electrically coupled to the first printed circuit board. The housing also includes a flexible ribbon having a first end electrically coupled to the first printed circuit board connector and a second end electrically coupled to the second printed circuit board, and a circuit board to circuit board connector (“BTB connector”) configured to be mounted to the first printed circuit board. The BTB connector includes a frame having a base. A backing plate formed on the base is configured to bias the first printed circuit board connector to the first printed circuit board. A pair of support arms extends from the base. Each arm of the pair of support arms includes a lock configured to receive the first printed circuit board and axially constrain the frame to the first printed circuit board in the first direction. The BTB connector also includes a stop configured to abut the second printed circuit board connector. The flexible ribbon applies a rotational moment to the frame about a rotational axis extending in a second direction orthogonal to the first direction, and the stop is configured to rotationally constrain the first printed circuit board connector to the first printed circuit board about the rotational axis in response to the rotational moment from the flexible ribbon.

The present disclosure provides, in yet another aspect, a method of mounting a circuit board to circuit board connector (“BTB connector”) to a printed circuit board. The printed circuit board extends along a longitudinal axis and includes a first printed circuit board connector and a second printed circuit board connector. The BTB connector includes a frame having a base with a backing plate formed on the base, and a pair of support arms extending from the base. Each support arm has a lock for receiving the printed circuit board. The BTB connector also includes a stop for abutting the second printed circuit board connector, and a catch for receiving the second printed circuit board connector. The method includes aligning the frame with the first printed circuit board connector so the backing plate can slide over the first printed circuit board connector and the catch on each of the support arms can receive the second printed circuit board connector, sliding the lock on each of the support arms into engagement with the printed circuit board to receive the printed circuit board therein, and sliding the catch on each of the support arms into engagement with the second printed circuit board connector to receive the second printed circuit board connector therein. The method also includes abutting the stop on each of the support arms into engagement with the second printed circuit board connector to rotationally constrain the first printed circuit board connector to the printed circuit board about a rotational axis oriented orthogonal to the longitudinal axis.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments, examples, aspects, and features that include the claimed subject matter, and explain various principles and advantages.

FIG. 1 is a cross-sectional side view of a board connector for use in a housing of an electronic device in accordance with some aspects.

FIG. 2 is a zoomed-in cross-sectional side view of FIG. 1.

FIG. 3A is a side view of a first printed circuit board connector in a connected position in accordance with some aspects.

FIG. 3B is a side view of the first printed circuit board connector of FIG. 3A in a disconnected position.

FIG. 4A is a perspective view of a board connector in accordance with some aspects.

FIG. 4B is an additional perspective view of the board connector of FIG. 4A.

FIG. 4C is a perspective view of the board connector of FIGS. 4A-4B with portions removed for clarity.

FIG. 5A is a perspective view of the board connector of FIG. 4A mounted to a master printed circuit board.

FIG. 5B is an additional perspective view of the board connector of FIG. 4A mounted to the master printed circuit board of FIG. 5A with portions removed for clarity.

FIG. 5C is an additional perspective view of the board connector of FIGS. 4A-4B mounted to the master printed circuit board of FIG. 5A with portions removed for clarity.

FIG. 6A is an example of a board-to-board connector for use with some aspects.

FIG. 6B is another example of a board-to-board connector for use with some aspects.

FIG. 7 is a perspective view of an electronic device utilizing the board connector of FIGS. 1 and 4A-4C according to some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments, examples, aspects, and features.

The apparatus and method components have been represented where appropriate by conventional symbols in the drawings, showing only those specific details that are pertinent to understanding the embodiments, examples, aspects, and features described and illustrated so as not to obscure the disclosure with details that will be readily apparent to those of ordinary skill in the art having the benefit of the description herein.

### DETAILED DESCRIPTION

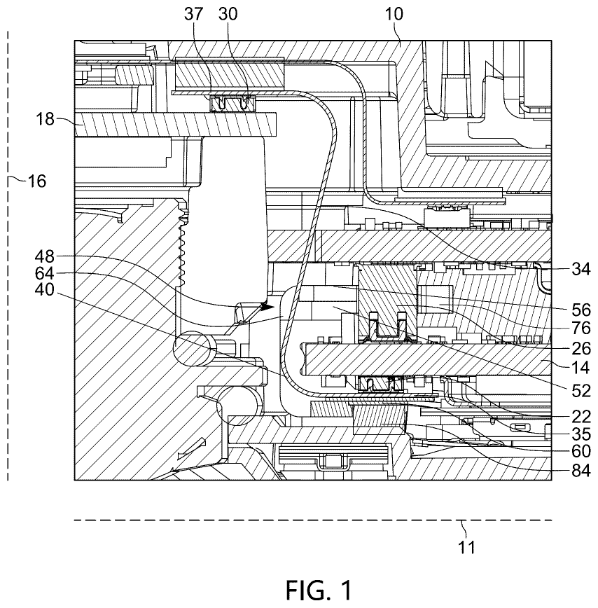

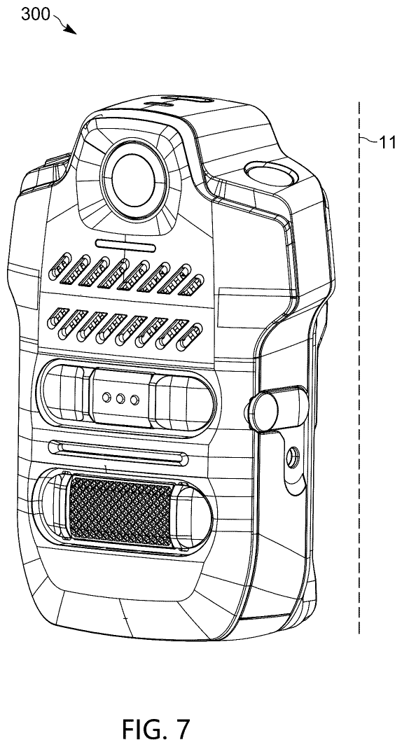

FIG. 1 illustrates an internal housing 10 of a portable electronic device 300 (FIG. 7), such as a camera. In the example shown, the internal housing 10 defines a longitudinal axis 11 (FIG. 7) and includes a master printed circuit board 14 mounted within the housing 10 and a slave printed circuit board 18 mounted within the housing 10 spaced from the master printed circuit board 14 in an axial direction along a mounting axis 16. The master printed circuit board 14 and the slave printed circuit board 18 are positioned within the housing 10 so that they each

extend along the longitudinal axis 11 and are oriented orthogonal to the mounting axis 16. The master printed circuit board 14 includes a first master printed circuit board connector 22 located on one side of the board 14 and a second master printed circuit board connector 26 located on the opposite side of the board 14. Each of the first and second master printed circuit board connectors 22, 26 are electrically coupled to the master printed circuit board 14. The slave printed circuit board 18 includes a slave printed circuit board connector 30 that is electrically coupled to the slave printed circuit board 18.

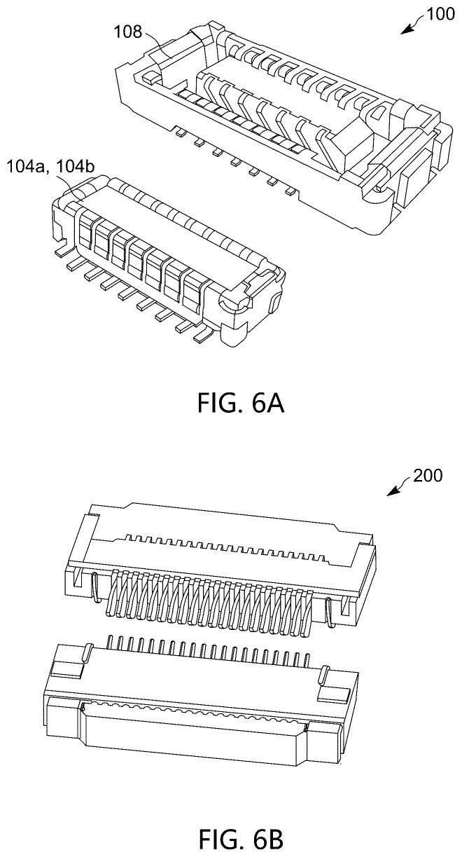

In some examples, the first and second master printed circuit board connectors 22, 26 and the slave printed circuit board connector 30 can be configured as a socket 108 as part of a board-to-board connector (“BTB connector”), such as the BTB connector 100 (FIG. 6A). In other examples, the first and second master printed circuit board connectors 22, 26 and the slave printed circuit board connector 30 can be zero-insertion-force connectors (“ZIF connectors”), such as the ZIF connector 200 (FIG. 6B), or other flexible printed circuit board connectors. In yet other examples, the first master printed circuit board connector 22 and the slave board connector 30 can have a stacking height of 0.80 mm.

With reference to FIGS. 1, 2, 3A-3B, a flexible ribbon 34 (e.g., a flexible printed circuit board) extends between the first master printed circuit board connector 22 and the slave printed circuit board connector 30 along the mounting axis 16 to electrically couple the master printed circuit board 14 to the slave printed circuit board 18. The flexible ribbon 34 includes a first end 35 having a first ribbon connector 104a (FIG. 6A) to electrically couple to the first master printed circuit board connector 22, and a second end 37 opposite the first end 35 having a second ribbon connector 104b to electrically couple to the slave printed circuit board connector 30. In some examples, the first and second ribbon connectors 104a, 104b can be the ZIF connector 200, or other flexible printed circuit board connectors.

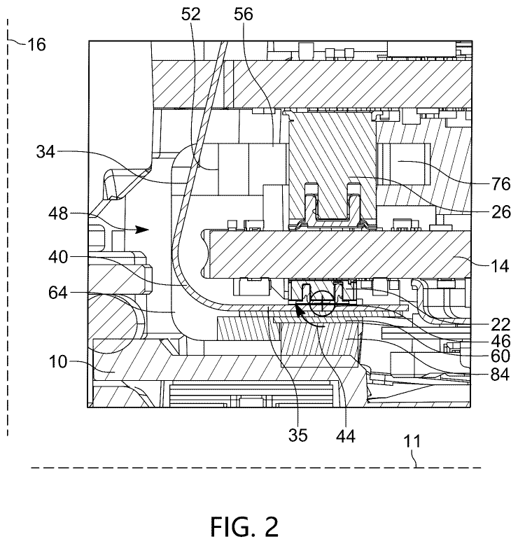

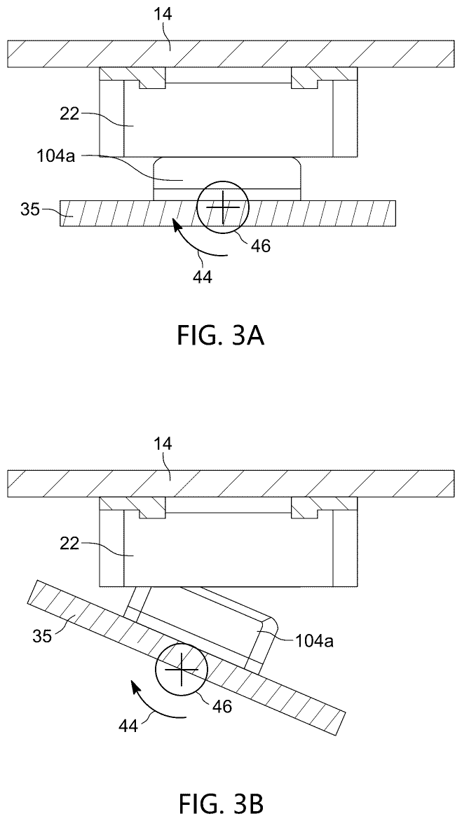

During assembly of the housing 10, to electrically connect the master printed circuit board 14 to the slave circuit board 18, a user first couples the first end 35 of the ribbon 34 with the first master printed circuit board connector 22 using the first ribbon connector 104a, and then guides the ribbon 34 up the mounting axis 16 to the slave printed circuit board connector 30. Next, the user couples the second end 37 of the ribbon 34 with the slave printed circuit board connector 30 using the second ribbon connector 104b. As the user couples the second end 37 of the ribbon 34 with the slave printed circuit board connector 30, a steep bend 40 is formed in the ribbon 34 adjacent the master printed circuit board 14. The steep bend 40 imparts a rotational moment 44 (FIG. 2) to the first ribbon connector 104a about a rotational axis 46 oriented orthogonal to the mounting axis 16. The force applied by the rotational moment 44 to first ribbon connector 104a can overcome a retention force of the first master printed circuit board connector 22, thereby moving the first ribbon connector 104a from the first printed circuit board connector 18 in a connected position (FIG. 3A), in which the first ribbon connector 104a is coupled to the first master printed circuit board connector 22 and the boards 14, 18 are electrically interconnected, to a disconnected position (FIG. 3B), in which the first ribbon connector 104a is decoupled from the first master printed circuit board connector 22, and the boards 14, 18 are electrically disconnected. In some examples, the retention force of the first master printed circuit board connector 22 is 13.5 Newtons.

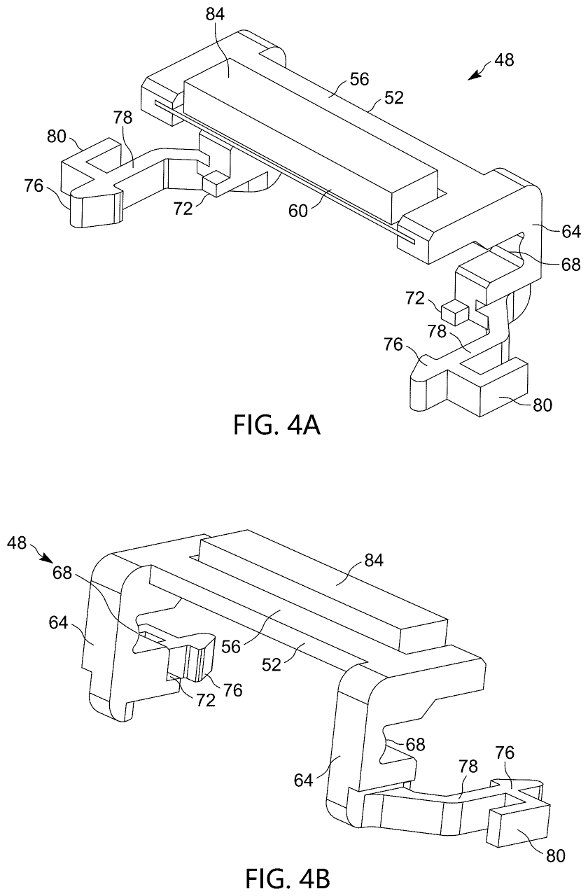

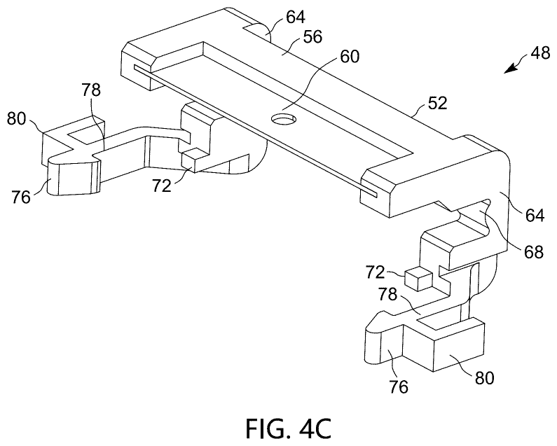

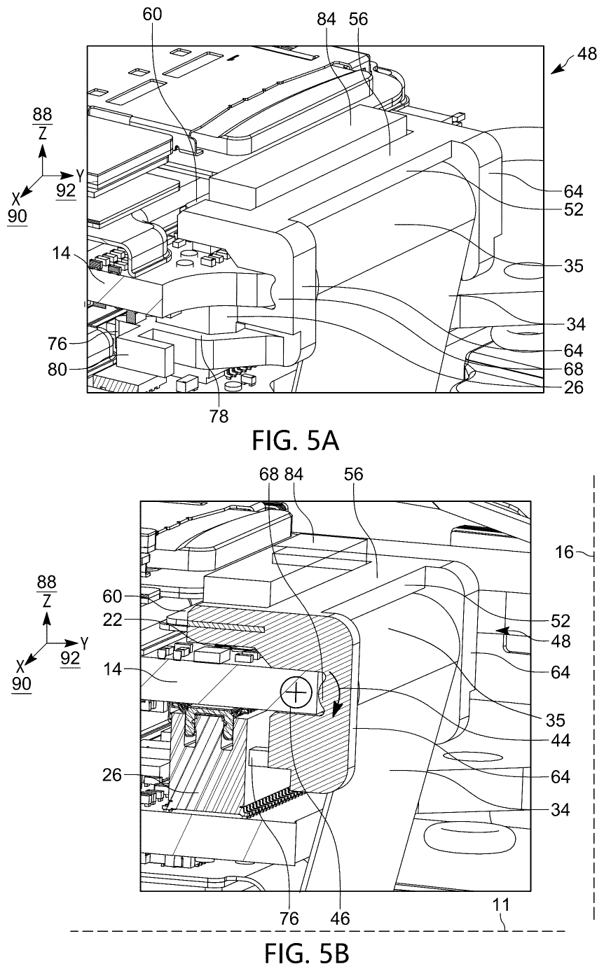

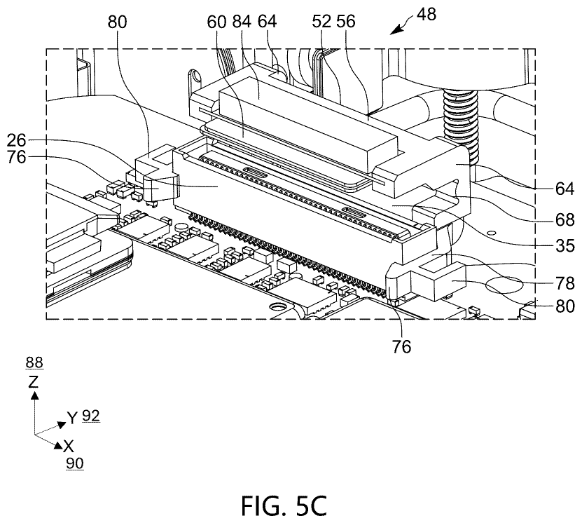

With reference to FIGS. 1, 4A-4C, and 5A-5B, to combat the first ribbon connector 104a from being electrically disconnected from the first master printed circuit board connector 22 due the force of the rotational moment 44, a board connector 48 is mounted to the master printed circuit board 14. The board connector 48 includes a frame 52 having a base 56, a backing plate 60 (FIG. 4C) formed on the base 56, and a pair of support arms 64 extending from the base 56. Each of the support arms 64 includes a locking slot 68 for selectively receiving the master printed circuit board 14, a stop tab 72 configured to abut the second master printed circuit board connector 26, and a catch 76 for removably coupling the frame 52 to the second printed circuit board connector 26 (FIG. 5C). Each of the catches 76 define an inner sidewall 78 for aiding in the retention of the second master printed circuit board connector 26. Each of the support arms 64 further includes a press tab 80 located on an outer surface of the inner sidewall 78 configured to be depressed by the user to elastically deform the frame 52 to allow the frame 52 to be removably coupled from the second master printed circuit board connector 26. The board connector 48 further includes a polymer pad 84 attached to the backing plate 60 configured to bias the backing plate 60 toward the first master printed circuit board connector 22 in an axial direction along the mounting axis 16 (FIG. 1).

In some examples, the backing plate 60 can be formed from a metallic material, such as steel, and the polymer pad 84 can be formed from a microcellular polyurethane foam, such as poron. In other examples, the backing plate 60 can have a thickness of 0.2 mm, and the polymer pad 84 can have a thickness of 1 mm. In yet other examples, the frame 52 can be composed of a polymer, such as plastic.

FIGS. 5A-5C illustrate the board connector 48 mounted to the master printed circuit board 14. To mount the board connector 48 to the first master printed circuit board 14, the user first aligns the frame 52 with the first master printed circuit board 14 so that the backing plate 60 will slide over the first side 35 of the flexible ribbon 34 to bias the first ribbon connector 104a into engagement with the first master printed circuit board connector 22. After the board connector 48 is properly aligned, the user then slides the locking slots 68 of respective arms 64 into engagement with the first master printed circuit board 14 so that the circuit board 14 is received therein. As the user presses the frame 52 into engagement with the second master printed circuit board connector 26, the user also slides the catches 76 of respective arms 64 over an outer surface of the second master circuit board connector 26 and into engagement with the outer surface of the circuit board connector 26 such that the catches 76 abut the outer surface of the circuit board connector 26 and the circuit board connector 26 is retained between respective inner sidewalls 78 of the catches 76 (FIG. 5C). To remove the board connector 48 from the master printed circuit board 14, the user compresses the press tabs 80 of respective arms 64 to axially deform respective arms 64 of the frame 52 in opposite directions along the rotational axis 46 and slides the catches 76 over the outer surface of the second master printed circuit board connector 26. At the same time, the user slides the slots 68 out of engagement with the second master printed circuit board connector 26 and the first side 35 of the flexible ribbon 34 to completely remove the board connector 48 from the master printed circuit board 14.

With continued reference to FIGS. 5A-5C, when the board connector 48 is mounted to the master printed circuit board 14, the board connector 48 is configured to counteract the rotational moment 44 being applied to the first ribbon connector 104a to prevent the first ribbon connector 104a from being electrically disconnected from the first master printed circuit board connector 22 during installation of the electrical components in the internal housing 10. To prevent the first ribbon connector 104a from being disconnected, the board connector 48 both axially and rotationally constrains the first ribbon connector 104a to the master printed circuit board 14 to maintain electrical contact with the first master printed circuit board connector 22. To axially constrain the first ribbon connector 104a, the board connector 48 prevents axial movement of the first ribbon connector 104a by axially constraining the frame 52 in three dimensions (e.g., x, y, and z) corresponding to three directions. The locking slots 68 of respective legs 64 prevent axial movement of the frame 52 along a z-axis 88 that is co-axial with the mounting axis 16. In this configuration, the backing plate 60 and polymer pad 84 work together to stabilize the frame 52 on the master printed circuit board 14 and provide a biasing force along the z-axis 88 to bias the first ribbon connector 104 a into engagement with the first master printed circuit board connector 22. The catches 76 of respective legs 64 prevent axial movement of the frame 52 along both an x-axis 90, that is co-axial with the rotational axis 46, and a y-axis 92 that is co-axial with the longitudinal axis 11. In this configuration, the frame 52 constrains the first ribbon connector 104a via the backing plate 60 and polymer pad 84 and prevents the ribbon connector 104 a from moving along both the x- and y-axes 90, 92. In the process of the first ribbon connector 104a being axially constrained in three-dimensions, the first master printed circuit board connector 22 is also axially constrained to the master printed circuit board 14 in the same manner. In some examples, the z-axis 88 corresponds to a first direction, the x-axis 90 corresponds to a second direction, and the y-axis 92 corresponds to a third direction.

To rotationally constrain the first ribbon connector 104 a to the first master printed circuit board connector 22 about the rotational axis 46, the frame 52 counteracts the rotational moment 44 by imparting a force equal on the second master printed circuit board connector 26 and opposite to the rotational moment 44 via the stop tabs 72 of respective arms 64. Similar as described above, in the process of the first ribbon connector 104a being rotationally constrained about the rotational axis 46, the first master printed circuit board connector 22 is also rotationally constrained to the master printed circuit board 14 in the same manner.

In some examples, the board connector 48 can improve the retention force of the first master printed circuit board connector 22 by 8.6 Newtons. In other examples, the retention force of circuit board connector 22 can be improved more or less.

By utilizing the board connector 48, users can avoid printed circuit board connectors, such as connectors, 22, 26, 30, 104, 200 from being detached during assembly of the internal electronic components in the housing 10. Often times, printed circuit board connectors detach or disconnect during the assembly process and are not noticed until too late in the assembly process, when a full breakdown of the electronic device is necessary to reconnect the disconnected printed circuit board connector. The occurrence of disconnected connectors is undesirable. So too is the time and energy required to reconnect detached connectors. The board connector 48 helps prevent printed circuit board connectors, such as connectors 22, 26, 30, 100, 200 from being disconnected and being detected too late during the assembly process, which saves a device manufacturer both time and money. In addition, the board connector 48 can be used across varying platforms of electronic devices that include circuit board connectors having varying stacking heights.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A circuit board to circuit board connector (“BTB connector”) configured to be mounted to a printed circuit board that includes a first printed circuit board connector and a second printed circuit board connector, the BTB connector comprising:
a frame having a base;
a backing plate formed on the base configured to bias the first printed circuit board connector to the printed circuit board; and
a pair of support arms extending from the base, the pair of support arms each including
a lock configured to receive the printed circuit board to axially constrain the frame to the printed circuit board in a first direction,
a stop configured to abut the second printed circuit board connector to rotationally constrain the first printed circuit board connector to the printed circuit board about a rotational axis extending in a second direction orthogonal to the first direction, and
a catch for removably coupling the frame to the second printed circuit board connector.

2. The BTB connector of claim 1, wherein the backing plate further comprises a polymer pad.

3. The BTB connector of claim 1, wherein the first printed circuit board connector is a board-to-board connector or a flexible printed circuit board connector.

4. The BTB connector of claim 1, wherein each of the pair of support arms further comprises
a press tab configured to elastically deform the frame upon being compressed by a user to allow the frame to be removed from the second printed circuit board connector.

5. The BTB connector of claim 1, wherein the lock is configured as a slot.

6. The BTB connector of claim 1, wherein the stop is configured as a tab.

7. The BTB connector of claim 1, wherein the catch further comprises an inner sidewall configured to retain the second printed circuit board connector therein.

8. The BTB connector of claim 7, wherein the printed circuit board is mounted with a housing defining a longitudinal axis, and the printed circuit board extends along the longitudinal axis in a third direction orthogonal to the first and second direction.

9. The BTB connector of claim 8, wherein the catch is configured to axially constrain the frame against movement with respect to the printed circuit board in the second and third direction.

10. An electronic device comprising:
a housing including a first printed circuit board and a second printed circuit board spaced from the first printed circuit board in a first direction;
a first printed circuit board connector electrically coupled to the first printed circuit board;
a second printed circuit board connector opposite the first printed circuit board connector electrically coupled to the first printed circuit board;
a flexible ribbon having a first end electrically coupled to the first printed circuit board connector and a second end electrically coupled to the second printed circuit board; and
a circuit board to circuit board connector (“BTB connector”) configured to be mounted to the first printed circuit board, the BTB connector including
a frame having a base,
a backing plate formed on the base configured to bias the first printed circuit board connector to the first printed circuit board, and
a pair of support arms extending from the base, the pair of support arms each having
a lock configured to receive the first printed circuit board and axially constrain the frame to the first printed circuit board in the first direction, and
a stop configured to abut the second printed circuit board connector; and
wherein the flexible ribbon applies a rotational moment to the frame about a rotational axis extending in a second direction orthogonal to the first direction; and
wherein the stop is configured to rotationally constrain the first printed circuit board connector to the first printed circuit board about the rotational axis in response to the rotational moment from the flexible ribbon.

11. The electronic device of claim 10, wherein the pair of support arms each further comprises
a catch for removably coupling the frame to the second printed circuit board connector, and
a press tab configured to elastically deform the frame upon being compressed by a user to allow the frame to be removed from the second printed circuit board connector.

12. The electronic device of claim 10, wherein the first printed circuit board connector is a board-to-board connector or a flexible printed circuit board connector.

13. The electronic device of claim 10, wherein the flexible ribbon extends from the first printed circuit board to the second printed circuit board in the first direction.

14. The electronic device of claim 10, wherein the first printed circuit board is a master control board and the second printed circuit board is a slave control board.

15. The electronic device of claim 10, wherein the electronic device is a portable camera.

16. The electronic device of claim 11, wherein the housing defines a longitudinal axis and each of the first printed circuit board and the second printed circuit board extend along the longitudinal axis in a third direction orthogonal to the first and second direction.

17. The electronic device of claim 16, wherein the catch is configured to axially constrain the frame against movement with respect to the first printed circuit board in the second and third direction.

18. A method of mounting a circuit board to circuit board connector (“BTB connector”) to a printed circuit board, the printed circuit board extends along a longitudinal axis and includes a first printed circuit board connector and a second printed circuit board connector, the BTB connector includes a frame having a base with a backing plate formed on the base, a pair of support arms extending from the base, the pair of support arms each have a lock for receiving the printed circuit board, a stop for abutting the second printed circuit board connector, and a catch for receiving the second printed circuit board connector, the method comprising:
aligning the frame with the first printed circuit board connector so the backing plate can slide over the first printed circuit board connector and the catch on each of the support arms can receive the second printed circuit board connector;
sliding the lock on each of the support arms into engagement with the printed circuit board to receive the printed circuit board therein;
sliding the catch on each of the support arms into engagement with the second printed circuit board connector to receive the second printed circuit board connector therein; and
abutting the stop on each of the support arms into engagement with the second printed circuit board connector to rotationally constrain the first printed circuit board connector to the printed circuit board about a rotational axis oriented orthogonal to the longitudinal axis.

19. The method of claim 18, further comprising axially constraining the frame to the printed circuit board via the lock on each of the support arms in a first direction orthogonal to the longitudinal axis.

20. The method of claim 19, biasing the first printed circuit board connector to the printed circuit board in the first direction with the backing plate.
